(19) United States
(12) Patent Application Publication
(10) Pub. No.: US 2005/0223386 A1
(43) Pub. Date: Oct. 6, 2005

(54) Comprehensive collection of hardware device information for diagnostics

(75) Inventor: Pawin Suthapong, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/817,634

(22) Filed: Apr. 1, 2004

(51) Int. Cl. G06F 9/46

(52) U.S. Cl. 719/313

(57) ABSTRACT

Techniques are disclosed to obtain information regarding an installed hardware device, whether or not the device is attached to the computer system. In a described implementation, a method includes collecting information regarding an installed device on a computing device. The information is presented (e.g., to an end-user with local access to the computing device). The installed device does not have to be attached to the computing device and no booting into a special mode (e.g., a troubleshooting mode) is required. The information may also be modified in response to a modification request (e.g., provided by an end-user through a graphical user interface). Furthermore, the information presented may include all data available to the operating system regarding the installed device.

### TECHNICAL FIELD

The present invention generally relates to information regarding hardware devices installed on a computing device and, in an implementation, to presenting and/or modifying the information where the device is not attached to the computing device.

### BACKGROUND

As computing devices become more commonplace, an ever-increasing number of functionalities are incorporated into these devices. As a result, more and more hardware and software modules (which provide these additional functionalities) need to be installed on a single computing device. The installation process generally requires installing software modules on the device and connecting the hardware to the computing device. While the additional modules provide additional functionality, they can also pose problems when they are not functioning properly.

Troubleshooting corrupted or incorrect device installations is not an easy task for the average user. Also, this problem is exacerbated in a remote support call scenario where a support technician has to verbally guide an end-user through various troubleshooting steps such as collecting hardware device information from scattered sources around the computing system. The collection of hardware device information may require accessing one or more highly sensitive tools.

For example, to obtain the requisite information regarding an installed device, a user may have to gather this information by activating a number of different tools such as a registry editor, system information (e.g., after a computing device is booted into a safe mode), device manager, or through programmatically calling setup application programming interface (API) functions. Applying these solutions can be time-consuming and could cost a service provider substantial amounts of money (e.g., in personnel time or connection costs). Also, a novice user may damage the computer system configuration if he or she uses these tools improperly.

Accordingly, the current solutions fail to provide an efficient, safe, and user-friendly methodology for accessing hardware device information for diagnostics.

### SUMMARY

Techniques are disclosed to obtain information regarding an installed hardware device, whether or not the device is attached to the computer system.

In a described implementation, a method includes collecting information regarding an installed device on a computing device. The information is presented (e.g., to an end-user with local access to the computing device). The installed device does not have to be attached to the computing device. The information may also be modified in response to a modification request (e.g., provided by an end-user through a graphical user interface).

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an exemplary method for presenting information regarding installed hardware devices.

FIG. 2 illustrates an exemplary graphical user interface which may be utilized to access hardware device information such as discussed with reference to FIG. 1.

FIG. 3 illustrates a general computer environment, which can be used to implement the techniques described herein.

### DETAILED DESCRIPTION

The following disclosure describes presentation of information regarding multiple installed devices (e.g., mouse, game pad, and the like) on a computing device, whether or not the devices are attached to the computing device. The information provided may have to otherwise be accessed through a number of sensitive tools that can damage a system configuration if used improperly. In an implementation, the information is presented without the need for booting the computing device into a special mode (e.g., a troubleshooting mode). Additionally, the information presented may include all data available to the operating system regarding the installed device.

Also, a user interface may enable a local end-user to select any device which has previously been installed and retrieve information about the device (e.g., device driver version, device ID, etc.) for diagnostics. This negates the necessity of using more complicated tools to access this information. In an implementation, these techniques are especially helpful in a remote support call scenario by providing a centralized and user-friendly diagnostics solution. Using the same user interface, the device information may be modified.

Furthermore, the information provided may enable a support person to more quickly resolve a problem with a hardware device. Hence, a (novice) user is not required to access sensitive system configuration utilities (such as the registry, device manager, system information, and the like), which may result in accidental damage to the configuration of other installed devices.

Presentation of Installed Hardware Device Information

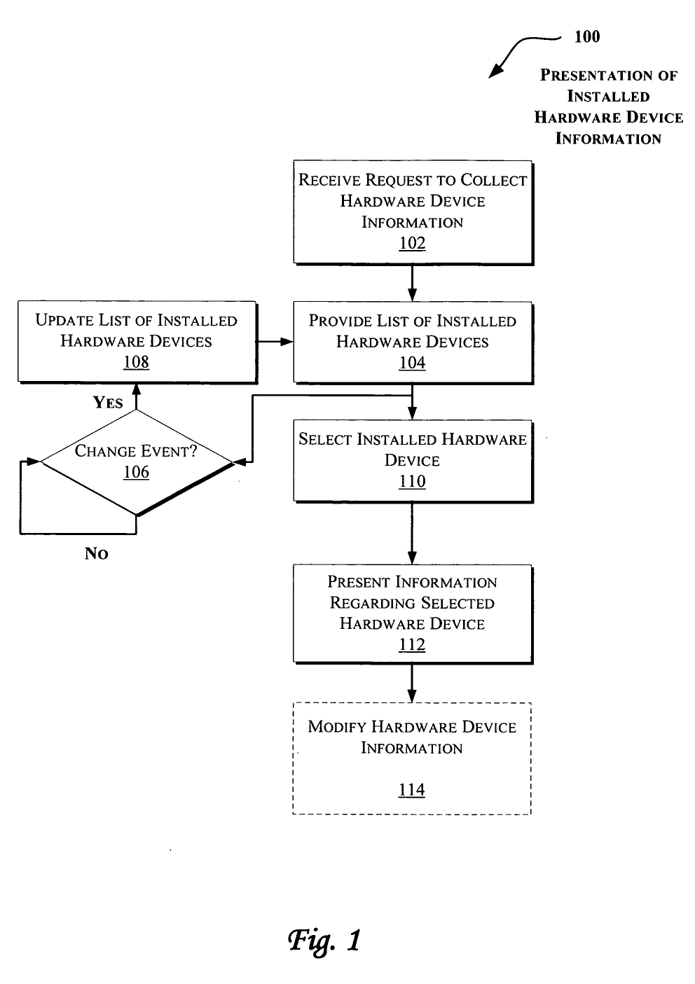

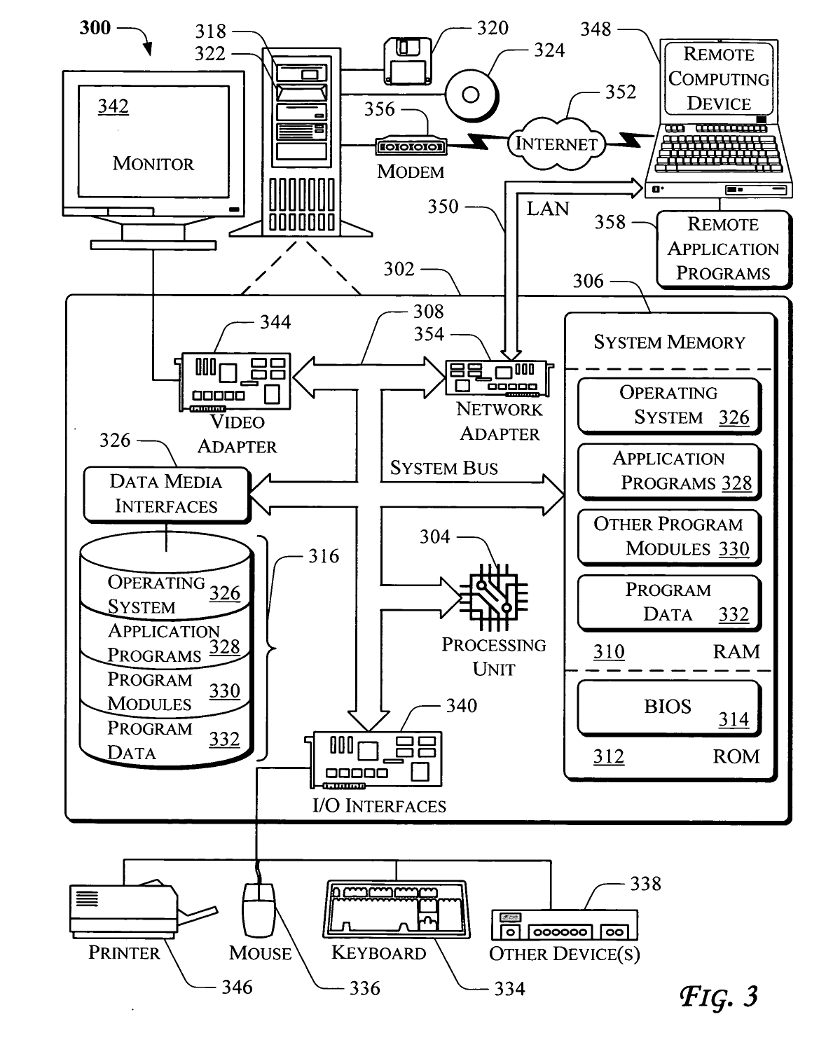

FIG. 1 illustrates an exemplary method 100 for presenting information regarding installed hardware devices. In an implementation, the method 100 may be performed in a general computing environment (as will be further discussed with reference to FIG. 3). The general computing environment may be running an operating system such as a graphical user interface-based operating system (e.g., Microsoft Windows® available from Microsoft Corporation of Redmond, Washington) The method (100) receives a request to collect hardware device information (102). For example, an end-user may be interested in diagnosing a problem with an installed hardware device (such as a mouse, game pad, keyboard, and the like). The user may issue a command to invoke the request for hardware device information (102). The command may be executed by the computing device (such as the computing environment discussed with reference to FIG. 3) without the need to boot the computing device into a special mode, e.g., a safe or troubleshooting mode. Generally, the safe or troubleshooting mode allows a user to troubleshoot the operating system and/or try to determine what is causing the operating system to not function correctly.

In an implementation, the command syntax may be provided by remote support personnel, for example, upon a local end-user contacting a customer support center. The end-user may contact the customer support center via regular phone, Internet phone (e.g., utilizing voice over Internet protocol), video phone, facsimile, electronic mail (Email), and the like (over a public telephone network, an intranet, the Internet, and the like). Also, the command syntax may be provided through a frequently asked question (FAQ) portion of a customer support center (such as information provided in a manual, through the Internet, and the like).

In response to the request for collection of hardware device information (102), a list of installed hardware device is provided (104). The installed devices may or may not be attached to the computing device (such as the general computing environment 300 of FIG. 3). A device may be attached to the computing device through one or more wires or wirelessly. Wireless attachment may be achieved by one or more wireless techniques such as acoustic, radio frequency (RF), infrared (IR), wireless fidelity (e.g., IEEE 802.11b wireless networking) (Wi-Fi), cellular, Bluetooth enabled, and other wireless media (as will be further discussed with reference to FIG. 3).

The list of installed hardware devices may be continually updated in an implementation. For example, a check may be performed to see whether a change event has occurred (106) such as a hot-plugging event where a new device is attached to the computing device or detached from the computing device. If a change event occurs (106), the list of the installed hardware devices is updated (108). Accordingly, the list of installed hardware devices may be dynamically updated.

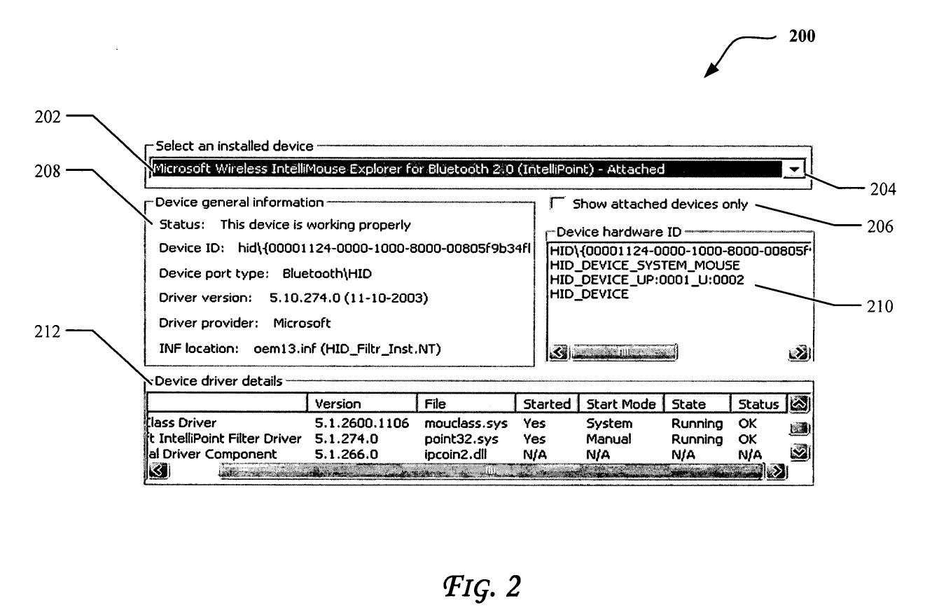

Upon selection of an installed hardware device (e.g., appearing on the list of stage 104), the information regarding the selected hardware device is presented (112). The selection may be performed by an end-user, e.g., by selecting an option on a user interface (as will be further discussed with reference to FIG. 2). Also, the information presented may include one or more of the following: device hardware identification (ID), device status, device ID, device port type, device driver version, device driver provider, device driver information file (INF) location and/or section, and/or a device drivers' file list (the associated services' status and services' information), as will be further discussed with reference to FIG. 2.

In one implementation, the presented information quickly indicates whether a driver installation has been correctly completed. For example, if some information is missing from the presented information (such as device driver INF location, driver versions, and the like), it can be quickly determined that the driver installation may have been incomplete.

The method 100 may further optionally allow modification of the presented hardware device information (114), e.g., in response to a modification request. For example, after the end-user provides the information to the customer support specialist (through the phone, via electronic mail (together with a screen shot or text copy of the device hardware information), the user may be instructed to delete or change the value of one or more data fields associated with the installed device hardware information to correct a problem with the device.

Exemplary Graphical User Interface

FIG. 2 illustrates an exemplary graphical user interface 200 which may be utilized to access hardware device information such as discussed with reference to FIG. 1. The interface 200 may be initialized via a user command (such as discussed with reference to the stage 102 of FIG. 1). The interface 200 may be installed at the same time as hardware device driver software, or after installation of the device driver.

The interface 200 includes a selection portion for selecting an installed device (202). As illustrated in FIG. 2, selection portion (202) may indicate whether an installed device is attached or remembered. Also, the selection portion (202) may have a pull-down button (204). Upon pressing the pull-down button (204), a list of all installed devices (whether attached or unattached) will be displayed and a user may click on any of the installed devices to enable presentation of hardware information about that device (such as discussed with reference to the stages 102, 104, and 110 of FIG. 1). Also, the list of installed devices may be updated dynamically as discussed with reference to the stages 106 and 108 of FIG. 1. Furthermore, selection of a checkbox (206) limits the list of devices (202) to attached devices only.

The user interface 200 also includes a device general information portion (208) that may present one or more device information such as status, device ID (e.g., a registry value found in the registry under the device's corresponding class registry key), device port type (e.g., the specific port type to which the device is connected such as serial, PS/2, universal serial bus (USB), Bluetooth, and the like), driver version (e.g., the version of the installed driver), driver provider (e.g., the provider of the installed driver), device driver INF location (e.g., the installation definition associated with the device), and the like.

A device hardware ID portion (210) may present one or more device hardware IDs associated with the selected device of portion 202. Device driver details (212) regarding the selected device of portion 202 may also be presented by the interface 200.

For example, the device driver details may include the list of one or more drivers names (or their description as illustrated in FIG. 2), their version information, file name (this may also include the full path of the file), status (whether started or not), start mode (e.g., which user started the driver), driver state (e.g., running, paused, stopped, and the like), and/or general status of the driver. Each column of the device driver details portion (212) may be dynamically resized to at least fit the longest string displayed on that column. Also, the list box height may provide a sufficient space to show three lines of drivers. If there are more than three drivers on the list, a horizontal scroll bar may appear.

In one implementation, a separate graphical user interface is used for each class of hardware devices (e.g., input devices, output devices, etc.). Alternatively, the graphical user interface may include a hardware device class portion (not shown) which enables an end-user to select a certain class of hardware devices. After such a selection, the selection portion (202) would only display installed devices for the selected class.

In an implementation, to make modifications to the presented hardware device information, the end-user simply selects the information to be modified and enters the new data (such as discussed with reference to the stage 114 of FIG. 1). In a further implementation, selections made in the interface 200 are persisted only while the application supporting the interface 200 is running. Alternatively, the selections may be stored so when a user returns to the interface 200, the last selections are retained.

Exemplary APIs

One or more APIs may be utilized in the Microsoft Windows®environment to provide the information discussed with reference to FIGS. 1 and 2. For example, to obtain a list of devices (such as discussed with reference to stage 104 of FIG. 1 and the portion 202 of FIG. 2), the following APIs may be utilized: SetupDiGetClassDevs and/or SetupDiEnumDevicelnterfaces.

To get properties of the devices, one or more of the following APIs may be utilized:
SetupDiGetDevicelnterfaceDetail
SetupDiGetDeviceRegistryProperty
SetupDiOpenClassRegKey
SetupDiOpenDevRegKey
SetupDiGetDevicelnstanceld
CM_Get_DevNode_Status

To obtain information regarding the drivers of the selected device (such as those discussed with reference to FIG. 2), one or more of the following APIs may be utilized:
SetupDiGetDevicelnstallParams
SetupDiBuildDriverlnfoList
SetupDiSetDevicelnstallParams

To obtain driver property information (such as those discussed with reference to FIG. 2), one or more of the following APIs may be utilized:
QueryServiceConfig
SetupDiCallClasslnstaller
SetupScanFileQueue
SetupCloseFileQueue
VerQueryValue

General Computing Environment

FIG. 3 illustrates a general computer environment 300, which can be used to implement the techniques described herein. For example, the computer environment 300 may be utilized to run the software program that provides the method 100 of FIG. 1 and/or the graphical user interface 200 of FIG. 2. The computer environment 300 is only one example of a computing environment and is not intended to suggest any limitation as to the scope of use or functionality of the computer and network architectures. The computer environment 300 should also not be interpreted as having any dependency or requirement relating to any one or a combination of components illustrated in the exemplary computer environment 300.

Computer environment 300 includes a general-purpose computing device in the form of a computer 302. The components of computer 302 can include, but are not limited to, one or more processors or processing units 304 (optionally including a cryptographic processor or co-processor), a system memory 306, and a system bus 308 that couples various system components including the processor 304 to the system memory 306.

The system bus 308 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 302 typically includes a variety of computer-readable media. Such media can be any available media that is accessible by computer 302 and includes both volatile and non-volatile media, removable and non-removable media.

The system memory 306 includes computer-readable media in the form of volatile memory, such as random access memory (RAM) 310, and/or non-volatile memory, such as read only memory (ROM) 312. A basic input/output system (BIOS) 314, containing the basic routines that help to transfer information between elements within computer 302, such as during start-up, is stored in ROM 312. RAM 310 typically contains data and/or program modules that are immediately accessible to and/or presently operated on by the processing unit 304.

Computer 302 may also include other removable/non-removable, volatile/non-volatile computer storage media. By way of example, FIG. 3 illustrates a hard disk drive 316 for reading from and writing to a non-removable, non-volatile magnetic media (not shown), a magnetic disk drive 318 for reading from and writing to a removable, non-volatile magnetic disk 320 (e.g., a “floppy disk”), and an optical disk drive 322 for reading from and/or writing to a removable, non-volatile optical disk 324 such as a CD-ROM, DVD-ROM, or other optical media. The hard disk drive 316, magnetic disk drive 318, and optical disk drive 322 are each connected to the system bus 308 by one or more data media interfaces 326. Alternatively, the hard disk drive 316, magnetic disk drive 318, and optical disk drive 322 can be connected to the system bus 308 by one or more interfaces (not shown).

The disk drives and their associated computer-readable media provide non-volatile storage of computer-readable instructions, data structures, program modules, and other data for computer 302. Although the example illustrates a hard disk 316, a removable magnetic disk 320, and a removable optical disk 324, it is to be appreciated that other types of computer-readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 316, magnetic disk 320, optical disk 324, ROM 312, and/or RAM 310, including by way of example, an operating system 326, one or more application programs 328, other program modules 330, and program data 332. Each of such operating system 326, one or more application programs 328, other program modules 330, and program data 332 (or some combination thereof) may implement all or part of the resident components that support the distributed file system.

A user can enter commands and information into computer 302 via input devices such as a keyboard 334 and a pointing device 336 (e.g., a “mouse”). Other input devices 338 (not shown specifically) may include a microphone, joystick, game pad, satellite dish, serial port, scanner, and/or the like. These and other input devices are connected to the processing unit 304 via input/output interfaces 340 that are coupled to the system bus 308, but may be connected by other interface and bus structures, such as a parallel port, game port, or a universal serial bus (USB). For example, the USB port may be utilized to connect a camera or a flash card reader to the computer environment 300.

A monitor 342 or other type of display device can also be connected to the system bus 308 via an interface, such as a video adapter 344. In addition to the monitor 342, other output peripheral devices can include components such as speakers (not shown) and a printer 346 which can be connected to computer 302 via the input/output interfaces 340.

Computer 302 can operate in a networked environment using logical connections to one or more remote computers, such as a remote computing device 348. By way of example, the remote computing device 348 can be a personal computer, portable computer, a server, a router, a network computer, a peer device or other common network node, game console, and the like. The remote computing device 348 is illustrated as a portable computer that can include many or all of the elements and features described herein relative to computer 302.

Logical connections between computer 302 and the remote computer 348 are depicted as a local area network (LAN) 350 and a general wide area network (WAN) 352. Such networking environments are commonplace in offices, enterprise-wide computer networks, intranets, and the Internet.

When implemented in a LAN networking environment, the computer 302 is connected to a local network 350 via a network interface or adapter 354. When implemented in a WAN networking environment, the computer 302 typically includes a modem 356 or other means for establishing communications over the wide network 352. The modem 356, which can be internal or external to computer 302, can be connected to the system bus 308 via the input/output interfaces 340 or other appropriate mechanisms. It is to be appreciated that the illustrated network connections are exemplary and that other means of establishing communication link(s) between the computers 302 and 348 can be employed.

In a networked environment, such as that illustrated with computing environment 300, program modules depicted relative to the computer 302, or portions thereof, may be stored in a remote memory storage device. By way of example, remote application programs 358 reside on a memory device of remote computer 348. For purposes of illustration, application programs and other executable program components such as the operating system are illustrated herein as discrete blocks, although it is recognized that such programs and components reside at various times in different storage components of the computing device 302, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various implementations.

An implementation of these modules and techniques may be stored on or transmitted across some form of computer-readable media. Computer-readable media can be any available media that can be accessed by a computer. By way of example, and not limitation, computer-readable media may include “computer storage media” and “communications media.”

“Computer storage media” includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically includes computer-readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, Wi-Fi, cellular, Bluetooth enabled, and other wireless media. Combinations of any of the above are also included within the scope of computer-readable media.

In one implementation, the hardware device whose information is accessed (such as discussed with reference to FIGS. 1 and 2) may be any device coupled with components of the general computer environment 300 (such as the processing units 304). Also, the hardware device may be a peripheral device of the general computer environment 300 (such as the mouse 336, keyboard 334, printer 346, and the like).

Conclusion

Thus, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
collecting information regarding an installed device on a computing device; and
presenting the information,
wherein the installed device is not attached to the computing device and the information is presented without booting the computing device into a special mode.

2. A method as recited in claim 1, wherein the information presented comprises all data available to an operating system running on the computing device regarding the installed device.

3. A method as recited in claim 1, wherein the special mode is a troubleshooting mode.

4. A method as recited in claim 1, further comprising modifying information regarding the installed device in response to a modification request.

5. A method as recited in claim 1, further comprising modifying information regarding the installed device in response to a modification request, wherein the modification request is one or more items selected from a group comprising change value and delete value.

6. A method as recited in claim 1, further comprising modifying information regarding the installed device in response to a modification request from a user.

7. A method as recited in claim 1, wherein the information is presented in response to a user selecting the installed device.

8. A method as recited in claim 1, wherein the information is dynamically updated in response to a change event.

9. A method as recited in claim 1, wherein the information is dynamically updated in response to a hot-plugging event.

10. A method as recited in claim 1, wherein the information regarding the installed device is one or more items selected from a group comprising device hardware ID, device status, device ID, device port type, device driver version, device driver provider, device driver INF location, device driver section, device drivers' file list, device drivers services' status, and device drivers' service information.

11. A method as recited in claim 1, wherein the information is presented to a local user.

12. A method as recited in claim 1, wherein the information regarding the installed device is provided to a remote support person.

13. A method as recited in claim 1, wherein the information regarding the installed device is provided to a remote support person through one or more communication channels selected from a group comprising a public telephone network, Internet, and an intranet.

14. A method as recited in claim 1, wherein the method quickly indicates whether a driver installation is incomplete.

15. An apparatus comprising:
a computing device; and
a hardware device installed on the computing device,
wherein information regarding the installed hardware device is presented when the installed device is not attached to the computing device and the information is presented without booting the computing device into a special mode.

16. An apparatus as recited in claim 15, wherein the information presented comprises all data available to an operating system running on the computing device regarding the installed device.

17. An apparatus as recited in claim 15, wherein the special mode is a troubleshooting mode.

18. An apparatus as recited in claim 15, wherein the information regarding the installed device is modified in response to a modification request.

19. An apparatus as recited in claim 15, wherein the information regarding the installed device is modified in response to a modification request and the modification request is one or more items selected from a group comprising change value and delete value.

20. An apparatus as recited in claim 15, wherein the information regarding the installed device is modified in response to a modification request from a user.

21. An apparatus as recited in claim 15, wherein the information is presented in response to a user selecting the installed device.

22. An apparatus as recited in claim 15, wherein the information is dynamically updated in response to a change event.

23. An apparatus as recited in claim 15, wherein the information is dynamically updated in response to a hot-plugging event.

24. An apparatus as recited in claim 15, wherein the information regarding the installed device is one or more items selected from a group comprising device hardware ID, device status, device ID, device port type, device driver version, device driver provider, device driver INF location, device driver section, device drivers' file list, device drivers services' status, and device drivers' service information.

25. An apparatus as recited in claim 15, wherein the information is presented to a local user.

26. An apparatus as recited in claim 15, wherein the information regarding the installed device is provided to a remote support person.

27. An apparatus as recited in claim 15, wherein the information regarding the installed device is provided to a remote support person through one or more communication channels selected from a group comprising a public telephone network, Internet, and an intranet.

28. An apparatus as recited in claim 15, wherein the method quickly indicates whether a driver installation is incomplete.

29. One or more computer-readable media having instructions stored thereon that, when executed, direct a machine to perform acts comprising:
collecting information regarding an installed device on a computing device; and
presenting the information,
wherein the installed device is not attached to the computing device and the information is presented without booting the computing device into a special mode.

30. One or more computer-readable media as recited in claim 29, wherein the information presented comprises all data available to an operating system running on the computing device regarding the installed device

31. One or more computer-readable media as recited in claim 29, wherein the special mode is a troubleshooting mode.

32. One or more computer-readable media as recited in claim 29, wherein the acts further comprise modifying information regarding the installed device in response to a modification request.

33. One or more computer-readable media as recited in claim 29, wherein the acts further comprise modifying information regarding the installed device in response to a modification request, wherein the modification request is one or more items selected from a group comprising change value and delete value.

34. One or more computer-readable media as recited in claim 29, wherein the acts further comprise modifying information regarding the installed device in response to a modification request from a user.
